(19) United States
(12) Patent Application Publication
(10) Pub. No.: US 2008/0215493 A1
(43) Pub. Date: Sep. 4, 2008

(54) Method and system for negotiation

(76) Inventors: Raymond Soo How Ong, Butterworth (MY); Joo Pheng Ooi, Butterworth (MY)

Correspondence Address: Frederic M. Douglas, Suite 340 PMB 114, 15333 Culver Blvd, Irvine, CA, 92604-3051, US

(21) Appl. No.: 11/713,260

(22) Filed: Mar. 2, 2007

(51) Int. Cl. G06Q 99/00; G06Q 40/00

(52) U.S. Cl. 705/80

(57) ABSTRACT

A system and method for negotiating over a network, comprises a selector for selecting a random length of time for negotiation; a receiving component, operably connected to said selector, for receiving an offer to purchase over a network; and a purchase fulfillment component, operably connected to said receiving component, wherein said purchase fulfillment component completes a purchase if said offer to purchase over a network matches or exceeds a threshold criterion and/or the elapsed amount of time for negotiation does not exceed said random length of time. A maximum negotiation iteration approach may be used to allow up to a predetermined number of negotiation proposals. A maximum negotiation time frame approach may be used to allow up to a predetermined period of elapsed time for negotiation proposals. The maximum negotiation iteration approach and the maximum negotiation time frame approach may be used together or with a variety of negotiation approaches.

### BACKGROUND OF THE INVENTION

The present invention generally relates to a method and system for conducting a negotiation (such as online negotiation, text negotiation, voice negotiation, and the like), more particularly, to a method and system for conducting an online transaction that allows automatic negotiation for purchasing goods and services, including providing a randomized number of negotiations and/or a randomized elapsed time for negotiations.

Individuals are increasingly seeking to conduct commerce over networks. The area of electronic commerce (“e-commerce”), including mobile commerce, is developing rapidly. E-commerce permits anyone, having access to a network, access to commercial transactions. However, some potential purchasers may prefer to transact with a human merchant, to negotiate to obtain better terms and to feel like a unique shopper. In addition, some potential customers may actually prefer to transact in a public shopping venue, such a mall, bazaar, or outdoor markets to reach various vendors, who compete to transact business with potential purchasers. However, from a seller's point of view, unless the negotiation process is unique, potential purchasers could potentially exploit the predictability that comes from repetitive bargaining behaviors.

As can be seen, there is a need for commerce over a network that makes repetitive bargaining behaviors less predictable. In addition, there is a need for commerce over a network that mimics individual transactions carried out in person by removing at least some of the predictability available in negotiations and by presenting information responsive to an offer for a proposed transaction.

### SUMMARY OF THE INVENTION

In one embodiment of the present invention, a system for negotiating over a network includes a selector for selecting a random length of time for negotiation; a receiving component, operably connected to said selector, for receiving an offer to purchase over a network, and a purchase fulfillment component, operably connected to said receiving component, wherein said purchase fulfillment component completes a purchase if said offer to purchase over a network matches or exceeds a threshold criterion and the elapsed amount of time for negotiation does not exceed said random length of time.

In another embodiment of the present invention, a method for negotiating over a network includes selecting a random number, receiving a plurality of negotiation proposals, summing a number of the plurality of negotiation proposals received, and accepting a negotiation proposal if the negotiation proposal meets a criterion and if the ordinal number of the negotiation proposal is not greater than said random number.

In still another embodiment of the present invention, an iterative method for optimizing negotiation over a network, including issuing a random number, summing a number of iterations of received negotiation proposals, presenting information responsive to said received negotiation proposals, and accepting said negotiation proposal if said negotiation proposal meets a criterion and if said number of iterations of said negotiation proposal is not larger than said random number.

In yet another embodiment of the present invention, a method of linking an advertisement to an online negotiation (it should be understood that the term “online negotiation,” as used herein, includes negotiation via voice, interactive voice response, message, SMD, MMS, text messaging, email, and the like) whereby the advertisement updates in relation to the content of the online negotiation, including displaying an online negotiation, displaying an advertisement adjacent to said online negotiation, and updating said advertisement in response to the content of said online negotiation.

These and other features, aspects and advantages of the present invention will become better understood with reference to the following drawings, description and claims.

### BRIEF DESCRIPTION OF THE DRAWINGS

FIG. 1 is a block diagram of a computer having access to a network for executing a computer executable negotiation system or method according to one embodiment of the present invention;

FIG. 2 is a block diagram showing the internal functional architecture of a computer;

FIG. 3 shows a typical topology of a computer network with computers connected to a network, the Internet;

FIG. 4 shows a system for managing transactions over a network;

FIG. 5 is a flow chart of a system for commerce over a network that provides a random length of time, or a random number of negotiation proposals, for negotiation between a system and a buyer;

FIG. 6 is a flow chart of a method for commerce over a network, via an instant messenger process, that provides a random length of time or a random number of negotiation proposals for negotiation between a system and a buyer;

FIG. 7 is a flow chart of a method for commerce over a network, using a direct call negotiation system, which provides a random length of time or a random number of negotiation proposals for negotiation between a system and a buyer;

FIG. 8 is a flow diagram of another embodiment of the present invention;

FIG. 9 is a plan diagram of a method of negotiation, according to yet another embodiment of the present invention; and

FIG. 10 is a diagram of a potential buyer's screen showing negotiation over a network, wherein the screen contains links to other offers, wherein the content of the links is updated in response to the negotiation.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention generally provides negotiation over a network, mimicking some of the characteristics of in person negotiation, which may comprise, for example, a randomized number of negotiations (or a randomized elapsed time limit for negotiation) over a network, which may or may not include either presenting information responsive to an offer of a proposed transaction or information from other potential sellers which is updated in response to the negotiation.

If a random number of negotiation proposals is selected, and if the buyer is not aware of the selected random number, then the buyer may be under pressure to negotiate in a lesser number of iterations because the negotiation system may terminate once the random number of negotiation proposals is reached. Similarly, if a random elapsed time limit is selected for negotiating, and if the buyer is not aware of the selected random elapsed time limit, then the buyer may be under pressure to negotiate in a lesser amount of time because the negotiation system may terminate once the random amount of elapsed negotiating time is reached. Unlike the prior art, the present invention also provides for a seller urging a negotiated price upwards (or a buyer urging a negotiated price downwards).

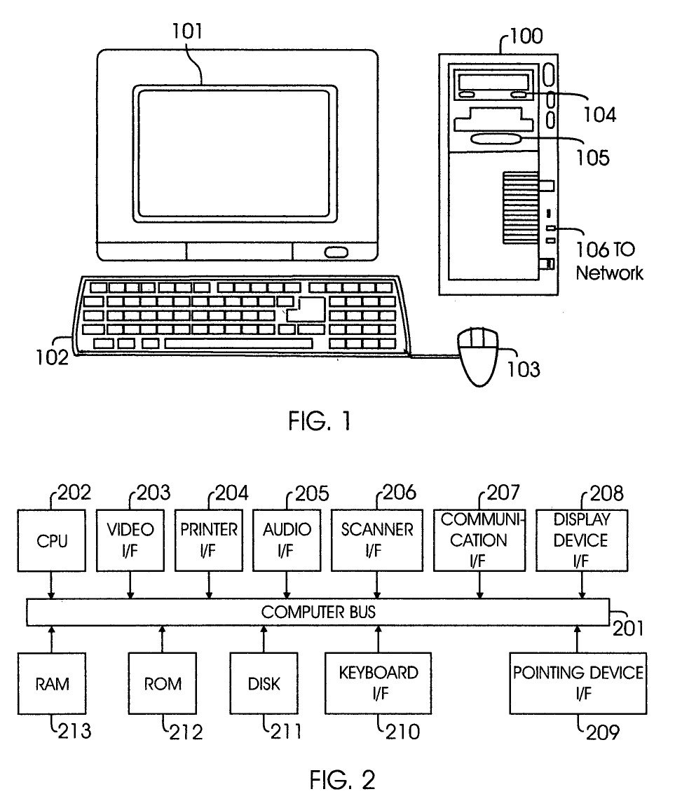

Referring now to the figures, FIG. 1 is a block diagram of a computer having access to a network, such as a global computer network (the Internet), a mobile network, an intranet, or any other suitable type of network, for executing a computer executable negotiation system according to one embodiment of the present invention. FIG. 1 includes a host computer 100 and a monitor 101. Monitor 101 may be a CRT type, an LCD type, or any other type of color or monochrome display. Also provided with computer 100 may be a keyboard 102 for entering text data and user commands, and a pointing device 103 (such as a mouse) for processing objects displayed on monitor 101.

Computer 100 may include a computer-readable memory medium such as a rotating disk 104 for storing readable data. Besides other programs, disk 104 can store application programs including web browsers by which computer 100 connects to a network, such as the Internet, and the systems described below, according to one aspect of the present invention.

Computer 100 can also access a computer-readable floppy disk storing data files, application program files, and computer executable process steps embodying the present invention or the like via a floppy disk drive 105. A removable media interface, such as a CD-ROM, DVD, USB drive, zip drive, and the like (not shown) may also be provided with computer 100 to access application program files, audio files and data files stored on removable media. The term, “removable media” as used herein includes any medium that participates in providing instructions to a processor (such as CPU 202) for execution. Such a medium may be in many forms, such as non-volatile media, volatile media, and transmission media. Non-volatile media may be optical or magnetic disks. Volatile media may include dynamic memory. Transmission media may be acoustic waves (such as via radio) or light waves (such as via infrared communication). Customary types of removable media may be, for example, a floppy disk, a hard disk, a flexible disk, magnetic tape, or any other magnetic media, a CD-ROM, DVD (digital versatile disk), or any other optical media, key punch cards, paper tape, any other physical media (such as with patterns or holes), a RAM, a PROM, and EPROM, a FLASH-EPROM, any memory chip or cartridge, a carrier wave, or any other medium that a computer may read.

A modem (including router, hub, switches, and the like), an integrated services digital network (ISDN) connection, or the like may also provide computer 100 with an Internet connection 106 to the World Wide Web (“WWW”). An Internet connection 106 may allow the computer 100 to download data files, audio files, application program files and computer-executable process steps embodying the present invention.

FIG. 2 is a block diagram showing the internal functional architecture of computer 100. As shown in FIG. 2, computer 100 may include a CPU 202 for executing computer-executable process steps and interfaces with a computer bus 201. Also shown in FIG. 2 are a communication interface 207 (such as a web interface, WAP interface, messenger interface, SMS interface, MMS interface, Voice-over Internet Protocol interface, and the like), a display device interface 208, a keyboard interface 210, a pointing device interface 209, an audio interface 205, and a rotating disk 211.

As described above, disk 104 may store operating system program files, application program files, web browsers, and other files. Some of these files may be stored on disk 104 using an installation program. For example, CPU 202 may execute computer-executable process steps of an installation program so that CPU 202 can properly execute the application program.

A random access main memory (“RAM”) 213 may also interface to computer bus 201 to provide CPU 202 with access to memory storage. When executing stored computer-executable process steps from disk 104 (or other storage media such as floppy disk 105, shown in FIG. 1, or WWW connection 106, shown in FIG. 1), CPU 202 stores and executes the process steps out of RAM 213.

Read only memory (“ROM”) 212 may be provided to store invariant instruction sequences such as start-up instruction sequences or basic input/output operating system (BIOS) sequences for operation of keyboard 102.

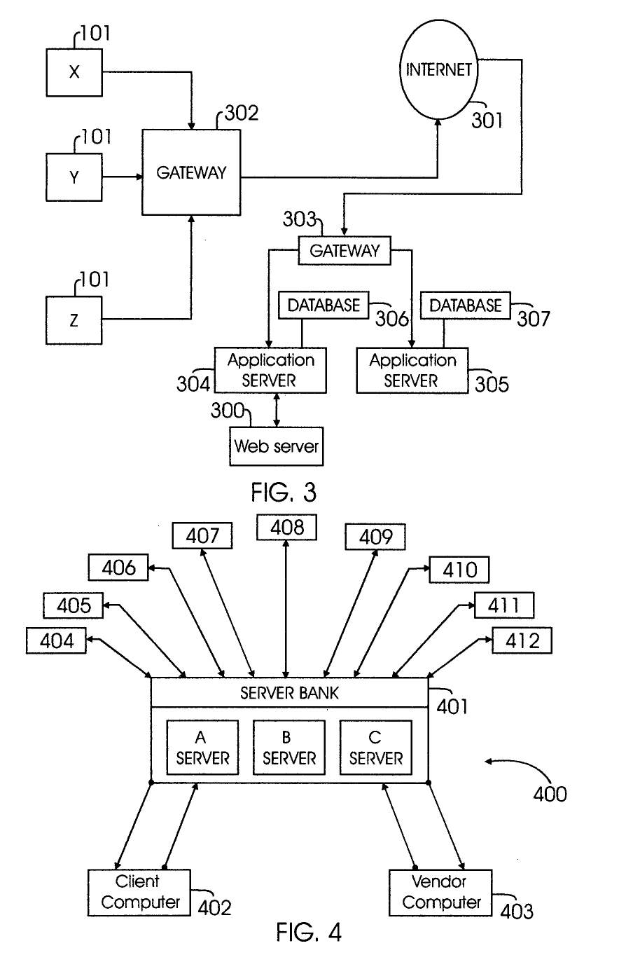

FIG. 3 shows a typical topology of a computer network with computers similar to computer 100, connected to the Internet. For illustration purposes, three computers X, Y, and Z are shown connected to the Internet 301 via communication interface 207 (shown in FIG. 2) through a gateway 302, where gateway 302 can interface N number of computers. Communication interface 207 may be a modem, network interface card, or a unit for providing connectivity to other computer systems over a network using protocols such as X.25, Ethernet, or TCP/IP, interactive voice response, or any device that allows, directly or indirectly, computer-to-computer communications, computer-to-telephone communications, and the like.

It is noteworthy that the invention is not limited to a particular number of computers. Any number of computers that can be connected to the Internet 301, or any other network, may be used.

FIG. 3 further shows a second gateway 303 that may connect a network of application servers 304 and 305 to the Internet 301. Application servers 304 and 305 may be connected with each other over a computer network. A web server 300 may be connected to an application server, such as application server 304. Application servers 304 and 305 can provide content, including information about a product and/or service, to a user from database 306 and/or 307. Application servers 304 and 305 can also host the present online negotiation system, according to the present invention.

The Internet connects thousands of computers worldwide through well-known protocols, for example, Transmission Control Protocol (TCP)/Internet Protocol (IP), into a vast network. Information on the Internet is stored worldwide as computer files, mostly written in the Hypertext Mark Up Language (“HTML”). Other mark up languages, e.g., Extensible Markup Language (“XML”) as published by W3C Consortium, Version 1, Second Edition, October 2000, ©W3C may also be used. The collection of all such publicly available computer files is known as the World Wide Web (“WWW”). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online, or via an Internet Service Provider, e.g., Earthlink. The web browser may run on any computer connected to the Internet. Currently, various browsers are available of which two prominent browsers are Netscape Navigator and Microsoft Internet Explorer. The Web Browser receives and sends requests to a web server and acquires information from the WWW. A web server is a program that, upon receipt of a request, sends the requested data to the requesting user. A standard naming convention known, as Uniform Resource Locator (“URL”), has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP). Although the above description uses the Internet as an example of a network, it should be understood that other types of networks may be suitable. For example, the present invention may be practiced with a mobile telephone network, such as a mobile web network. A mobile telephone web network may connect through a PBX (private branch exchange). Often, a mobile telephone web network will use WAP programming languages such as VXML, xml, wml, java, and the like.

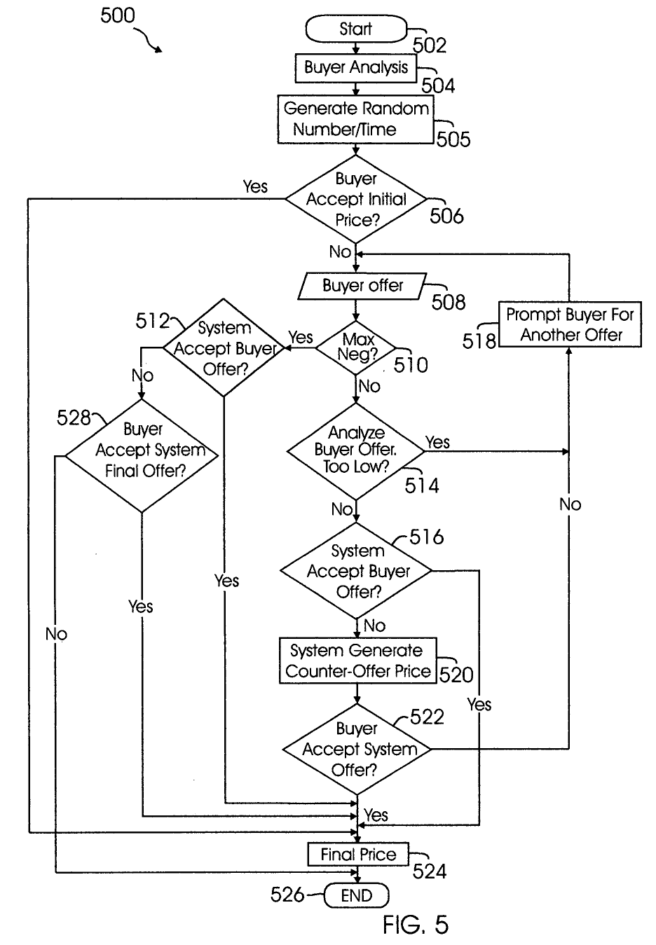

FIG. 4 shows a system 400 for managing online negotiation. Computer server bank 401 may include multiple server computers (“servers”) for processing information requests between client computers 402 (such as buyer computers) and vendor computers 403 (such as computers for sellers of products or services). Although FIG. 4 shows an exemplary computer server bank 401 to include three servers A, B, and C, any number of servers may be used.

Continuing with FIG. 4, the server bank 401 may be attached to a communication link (such as the Internet, a mobile network, or an intranet) with multiple vendor locations 404-412. Although FIG. 4 shows an exemplary group of nine buyer/vendor locations 404-412, any number of buyer/vendor locations may be used.

FIG. 5 shows a flow chart of an example of operation of one embodiment of a system 500 for negotiation over a network. The system 500 for negotiating starts 502 when a buyer decides to negotiate the purchase of an item. The buyer may negotiate for the purchase of more than one item (including more than one type of item, or even combining different items), sometime with an effort to obtain a better price. Although this discussion uses the example of negotiating the price of an item, it should be understood that this discussion applies equivalently to negotiating the purchase of a service, a commodity, or any other type of suitable negotiation. A negotiation system may represent a seller and offer a price to the buyer based on price ranges selected by the seller and system predefined logic. In another situation, the negotiation system may represent a seller and offer a price to the buyer based on an initial offer price. In buyer analysis 504, the system may begin to analyze buyer information when the buyer enters into a negotiation environment.

In 505, the system may select a random number (such as a random number of negotiation proposals or a random amount of elapsed time for negotiating) and/or a random elapsed time for negotiation. After a plurality of negotiation proposals, the system may sum a number of the plurality of negotiation proposals received and accept a negotiation proposal if the negotiation proposal meets a criterion.

The criterion may be any suitable negotiation criterion, such as the price of an item or service, the quantity of an item or service, the quality of an item or service, or any other relevant factor for negotiation.

The negotiation may be conducted over a network, such as a global computer network (such as the Internet), an intranet, a wireless network, a mobile network, a mobile telephone network, an SMS (short message service) network, and the like.

For the situation wherein the number of negotiation proposals is controlled, the system may terminate the negotiation if the ordinal number of the negotiation proposal is greater than said random number.

In another embodiment of the present invention, the system may select a random length of time for presenting negotiation proposals, receiving a plurality of negotiation proposals, and terminates the negotiation if the elapsed amount of time for negotiation exceeds said random length of time

Continuing with FIG. 5, if the buyer accepts an initial price for an item 506, then the negotiation process is avoided. The final price 524 is set-up and the process reaches the end 526. If the buyer does not accept the initial price, then the method continues at 508, wherein the buyer makes an offer, such as an offer price. The system checks whether the maximum number of negotiation proposals or maximum amount of negotiation time 510 has been reached. If the maximum number of negotiation proposals is not reached (or the maximum amount of elapsed time allotted for negotiation is not expired), then the system analyzes the buyer's offer to see if the offer is too low 514. If the buyer's offer is too low, then the system prompts the buyer to make another offer 518. The buyer's subsequent offer 508 is then analyzed as described above.

If the maximum number of negotiation proposals or maximum amount of negotiation time 510 has been reached, then the system accepts the buyer's offer 512 if the buyer's offer is within an acceptable criterion range selected by the seller, such as a range including a minimum value and a maximum value (optional). In this situation, the final price 524 is determined and the process ends 526.

If the buyers offer is not within an acceptable criterion range (such as within a suitable price range), then the buyer is offered a chance to accept the system's final offer 528. If the buyer accepts the system's final offer, then the final price 524 is determined and the process ends 526. If the buyer doe not accept the system's final offer, then the process ends 526.

If the buyer's offer is not too low 514, then the system decides whether to accept the buyers offer 516. If the system accepts the buyer's offer, then the final price 524 is determined and the process ends 526. If the system does not accept the buyer's offer, then the system generates a counter-offer 520.

If the buyer accepts this system offer 522, then the final price 524 is determined and the process ends 526. If the buyer does not accept this system offer 522, then the system prompts the buyer to make another offer 518. The buyer's subsequent offer 508 is then analyzed as described above.

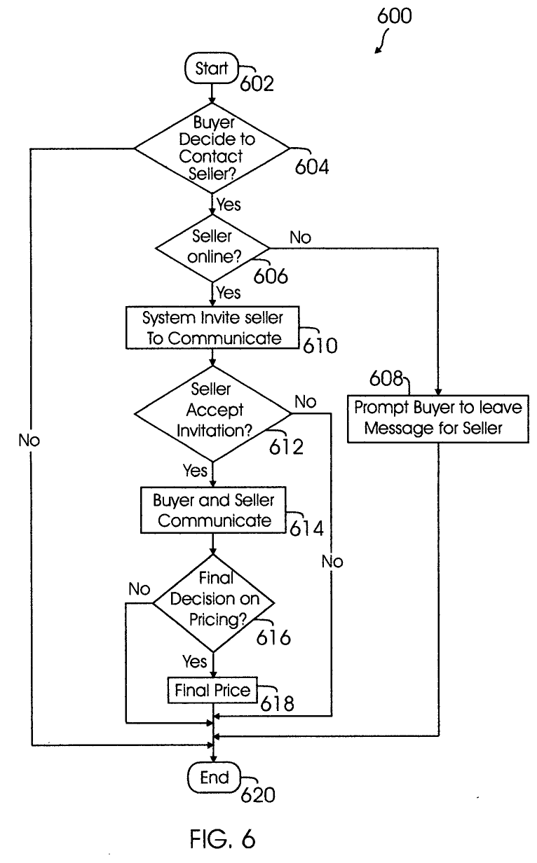

A flow chart of a method 600 for commerce over a network, via an instant messenger process, is shown in FIG. 6. The method 600 starts at 602, when the buyer decides whether to contact the seller (such as after a failed negotiation) 604. If the buyer decides not to contact the seller, then the method ends 620. The buyer may decide to contact the seller for more information, such as when attempting to obtain a better offer from the seller. If the buyer decides to contact the seller, then the system determines whether the seller is online (or otherwise available via a communication device) 606. The buyer and seller may communicate with any suitable communication method, such as via SMS, interactive voice recognition, mobile messaging service, email, radio, voice-over Internet protocol, and the like.

If the seller is not online (or not otherwise available), then the system prompts the buyer to leave a message for the seller at 608. If the seller is online (or otherwise available), then the system may invite the seller to participate in a chat room, at 610, for further discussion. If the seller accepts the invitation at 612, then the buyer and seller may communicate regarding terms of a contemplated transaction. Any chat history may be saved into a database as part of a transaction agreement. If the seller does not accept the invitation at 612, then the process ends at 620.

If the buyer and seller arrive at a final decision on the terms of a transaction (such as a price, quality, quantity, delivery time, and the like) at 616, then a final price may be set at 618 and the process may end at 620. If the buyer and seller do not arrive at a final decision on the terms of the transaction, then the process may end at 620.

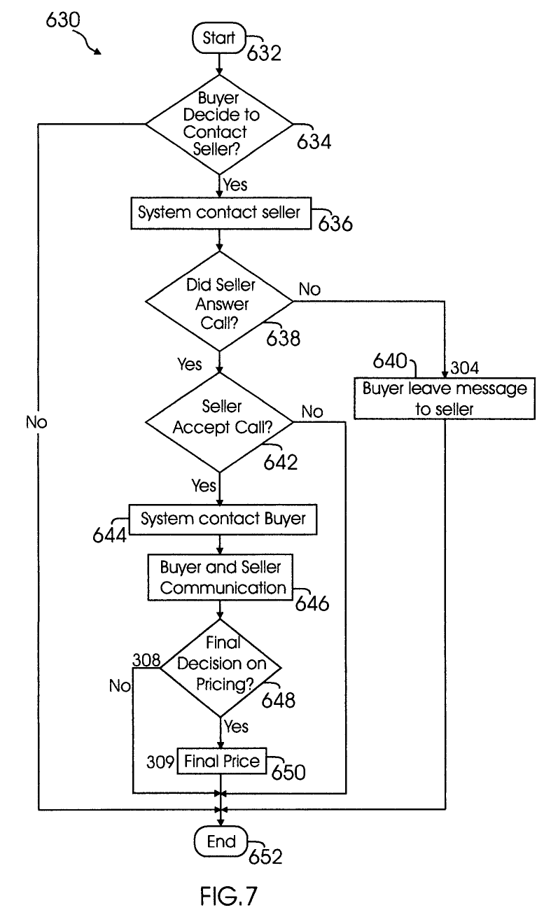

Another embodiment of the present invention is shown in FIG. 7. The method 630 may be a method for instant direct call negotiation. The method may start at 632. If the buyer decides not to contact the seller at 634, then the method 630 may end at 652.

If the buyer does decide to contact the seller at 634, then the system may contact the seller via any suitable communication method (such as voice over internet protocol, VOIP; SMS; telephone; wireless network; mobile messaging service, MMS; chat, or any other suitable method). If the seller answers a call for negotiation at 638, then the seller may accept the call for negotiation at 642. If the seller does not accept the call at 642, then the process ends at 652. If the seller does not answer the call, then the buyer may leave a message for the seller at 640.

Continuing with FIG. 7, the system may contact the buyer to continue the negotiation process at 644. Then the buyer and seller may communicate at 646 regarding the terms of the contemplated transaction.

If the buyer and seller arrive at a final decision on the terms of a transaction (such as a price, quality, quantity, delivery time, and the like) at 648, then a final price may be set at 650 and the process may end at 652. If the buyer and seller do not arrive at a final decision on the terms of the transaction, then the process may end at 652.

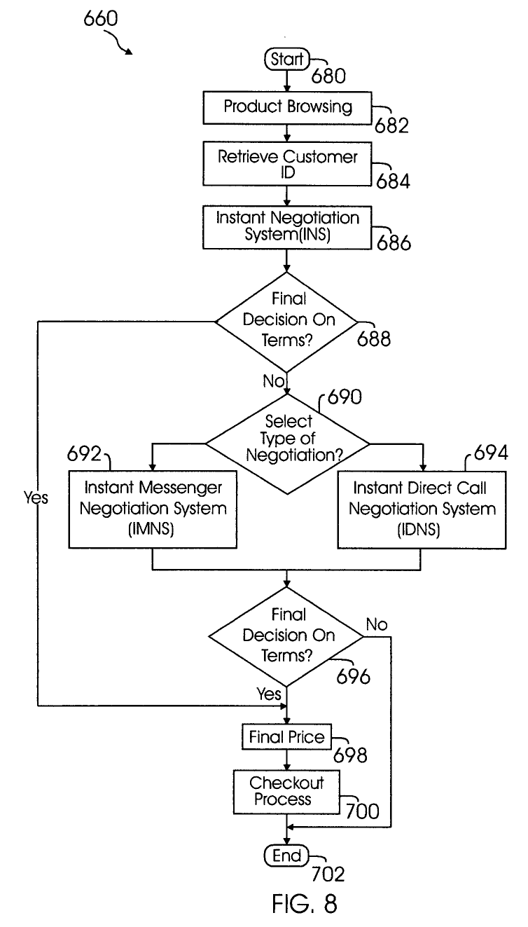

Yet another embodiment of the present invention is shown in FIG. 8. A method 660 may start at 680. A buyer may browse for an item at 682. A customer ID may be retrieved at 684. An instant negotiation system may commence at 686.

If a final decision is made as to the terms of a contemplated transaction at 688, then the final price may be set at 698. If a final decision is not made at 688, then the buyer and seller may select a type of negotiation at 690. At least two types of negotiation are an instant messenger negotiation system and an instant direct call negotiation system.

After the buyer and seller chooses a type of negotiation and completes the chosen type of negotiation, then a final decision may be made regarding the terms of the contemplated transaction. If a final decision is not reached, then the process may end at 702. If a final decision is reached, then a final price may be set at 698. A checkout process 700 may proceed to arrange for payment and delivery terms. After the checkout process 700, then the method may end at 702.

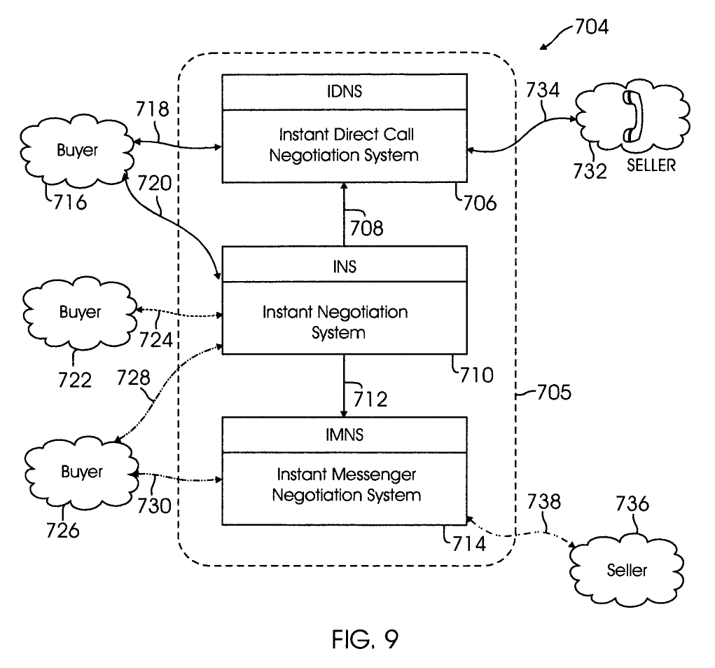

FIG. 9 is a plan diagram of a method 704 for negotiation. A plurality of buyers 716, 722, 726, may communicate with a plurality of sellers 732, 736 via a negotiation network 705. The negotiation network 705 may be comprised of an instant direct call negotiation system 706, an instant negotiation system 710, and/or an instant messenger negotiation system 714. The negotiation systems 706, 710, 714 may communicate via communication channels 708, 712.

Communication among the buyers 716, 722, 726, the sellers 732, 736, and the negotiation network may occur in any suitable manner of communication. For example, buyer 716 may communicate via wireline 718 and an intranet 720, while seller 732 may communicate via a telephone wireline 734. Buyer 724 may communicate via a wireless connection 724, while buyer 726 may communicate via SMS 728 and radio signal 730. Similarly, seller 736 may communicate via MMS connection 738.

It should be understood that any communication, in any aspect of the present invention, may be conducted via VOIP, interactive voice recognition (IVR), wireless network, wireline network, Internet, intranet, radio, instant messaging, electronic mail, telephone, telegraph, postal mail, or any suitable method of communication.

The negotiations herein may be accomplished by a seller urging a negotiation proposal towards either the minimum value or the maximum value within a criterion range of values acceptable to the seller. For example, if a seller chooses that an item price within the range of from $20 to $40 is acceptable, the buyer may propose to pay $21 for the item (without knowing what is the sellers acceptable range). After receiving the offer of $21, the negotiation system may prompt the buyer for a higher offer, by communicating a desire to not accept the $21 offer. If the buyer chooses to offer a higher price, the system may still urge the buyer to make an even higher offer until the offer reaches farther towards the seller's maximum value range. If the buyer offers, say $25, the system may continue to urge the offer to be raised higher. If the buyer makes a final offer of, say, $35, then the system may indicate that the $35 offer is acceptable. In this manner, the system avoids revealing to the buyer that the lower offer of $21 was acceptable to the seller.

The method of negotiation may be conducted such that the identity of the source of an offer to purchase over a network is confidential. Also, an offer to purchase over a network may be confidential.

A method of linking an advertisement (or sponsorship notice and the like) to an online negotiation may occur such that an advertisement updates in relation to the content of the online negotiation. The method may comprise displaying an online negotiation; displaying an advertisement adjacent to say online negotiation; and updating said advertisement in response to the content of said online negotiation.

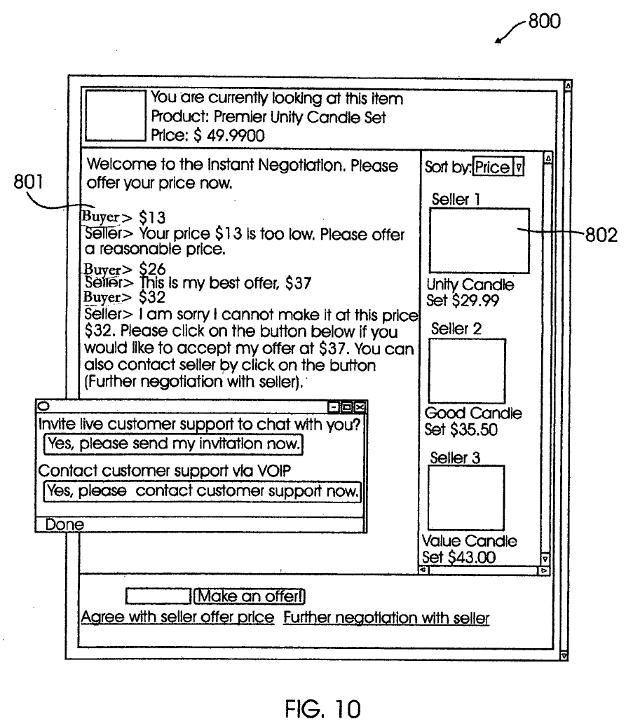

FIG. 10 shows an example of a screen display 800 from the operation of a method of linking an advertisement (or sponsorship notice and the like) to an online negotiation, including displaying an online negotiation 801, displaying an advertisement (or sponsorship notice and the like) adjacent to said online negotiation 802, and updating said advertisement (or sponsorship) 802 in response to the content of said online negotiation 801. Further, the advertisement (or sponsorship notice and the like) may be, but is not limited to, a hyperlink, an applet, a picture, a sound, streaming media, an editable form, or an offer to negotiate. In addition, the method may include assessing the past negotiation history of at least one of user. Also, the system may include software for processing an offer to purchase over a network to be made in and processed in internationally accepted formats. Further, the system may include software for converting a numerical value relating to said offer to purchase over a network from a first unit of currency to a second unit of currency. Also, the source of the offer to purchase over a network may be confidential.

It should be understood, of course, that the foregoing relates to exemplary embodiments of the invention and that modifications may be made without departing from the spirit and scope of the invention as set forth in the following claims.

What is claimed is:

1. A method for negotiating over a network, comprising:
selecting a random number;
receiving a plurality of negotiation proposals;
summing a number of the plurality of negotiation proposals received; and
accepting a negotiation proposal if the negotiation proposal meets a criterion and if the ordinal number of the negotiation proposal is not greater than said random number.

2. The method of claim 1, wherein said criterion is a price.

3. The method of claim 1, wherein said criterion is a quantity.

4. The method of claim 1, wherein said criterion is a quality.

5. The method of claim 1, wherein said network comprises the Internet.

6. The method of claim 1, wherein said network comprises an intranet.

7. The method of claim 1, wherein said network comprises a mobile network.

8. The method of claim 1, wherein said network comprises a wireless network.

9. The method of claim 1, wherein the identity of the source of said offer to purchase over a network is confidential.

10. The method of claim 1, wherein said offer to purchase over a network is confidential.

11. The method of claim 1, further comprising determining an acceptable criterion range, including a minimum value and a maximum value, and urging a negotiation proposal towards either the minimum value or the maximum value.

12. A method for negotiating over a network, comprising:
selecting a random length of time for presenting negotiation proposals;
receiving a plurality of negotiation proposals;
summing a number of the plurality of negotiation proposals received; and
accepting a negotiation proposal if the negotiation proposal meets a criterion and if the elapsed amount of time for negotiation does not exceed said random length of time.

13. The method of claim 12, wherein said criterion is a price.

14. The method of claim 12, wherein said criterion is a quantity.

15. The method of claim 12, wherein said criterion is a quality.

16. A method of linking an advertisement to a negotiation over a network, comprising:
displaying negotiation over a network;
displaying an advertisement adjacent to said negotiation over a network; and
updating said advertisement in response to the content of said negotiation over a network.

17. The method of claim 16, further comprising determining an acceptable criterion range, including a minimum value and a maximum value, and urging a negotiation proposal towards either the minimum value or the maximum value.

18. The method of claim 16, further comprising;
selecting a random number;
receiving a plurality of negotiation proposals;
summing a number of the plurality of negotiation proposals received; and
accepting a negotiation proposal if the negotiation proposal meets a criterion and if the ordinal number of the negotiation proposal is not greater than said random number.

19. The method of claim 18, wherein said criterion is a price.

20. The method of claim 18, wherein said criterion is a quantity.
